(19) United States
(12) Patent Application Publication
(10) Pub. No.: US 2009/0214702 A1
(43) Pub. Date: Aug. 27, 2009

(54) PROCESSING METHOD AND DEVICE FOR EXTRUSION OF BEER ADJUNCT WITH OR WITHOUT ENZYMES ADDED, AND SACCHAROGENIC METHOD FOR EXTRUDED BEER ADJUNCT

(75) Inventor: Shen Dechao, Shandong (CN)

Correspondence Address: MICHAEL BEST & FRIEDRICH LLP, 100 E WISCONSIN AVENUE, Suite 3300, MILWAUKEE, WI, 53202, US

(73) Assignee: Shandong University of Technology, Shandong (CN)

(21) Appl. No.: 12/327,167

(22) Filed: Dec. 3, 2008

(30) Foreign Application Priority Data
Feb. 25, 2008 (CN) 200810014639.X

(51) Int. Cl. C12G 3/08; B01F 15/02

(52) U.S. Cl. 426/14; 366/186

(57) ABSTRACT

This invention relates generally to the field of beer brewing, specifically to a processing method and a device for the extrusion of beer adjunct with or without enzymes added, and a saccharogenic method for the extruded beer adjunct. The processing method and the device of this invention are such that the starch in the beer adjunct extruded with or without enzymes added can be degraded more thoroughly, the saccharification time can be shortened, and the recoverable ratio of wort extract and therefore the production yield of beer can be increased further, as compared to the processing method, the device and the saccharogenic method of the prior art extrusion-cooking version. Meanwhile this invention spared the mashing and liquefying of beer adjunct mash at the temperature of 100 degrees C. as is common in the technology of traditional beer production.

### RELATED APPLICATION DATA

This application claims the benefit under 35 U.S.C. §119(a) of currently-pending Chinese Patent Application No. CN200810014639.X filed Feb. 25, 2008, the entire contents of which are hereby incorporated by reference.

### FIELD OF THE INVENTION

This invention relates generally to the field of beer brewing. Specifically, this invention relates to a processing method and a device for the extrusion of beer adjunct with or without enzymes added, and a saccharogenic method for the extruded beer adjunct.

### BACKGROUND

Researchers in China and abroad had studies on the extrusion-cooking of beer adjunct from early 1980's to early 1990's. They found that the extrusion-cooked beer adjunct could brought about increased recoverable ration of wort extract of wort, shortened fermentation period of beer, reduced consumption of malt and therefore decreased cost of beer production. Meanwhile, the traditional processes and apparatus for the cooking-gelatinization of beer adjunct could also be spared. However, these researches came to a halt due to the difficulties in the saccharification and filtration of the resulting mash. As K. T. Westwood (1994) pointed out: “. . . , in spite of extensive efforts, technical difficulties arising from the use of extruded cereals in brewing (high and unacceptable wort viscosities) have not been overcome to date. As a consequence, as far as the author is aware, extruded cereal adjuncts are not being used in the brewing beer industry.” (N. D. Frame. The Technology of Extrusion Cooking. Printed in Great Britain by St. Edimundsbury Press, 1994:237-250).

Chinese patents CN00122033.0 (Title: Processing method and processing device for the extrusion-expanding of beer adjunct, and saccharogenic method for the extrusion-expanded beer adjunct; Application date: Aug. 3, 2000), CN200510045328.6 (Title: Processing method and processing device for the extrusion-cooking of beer adjunct, and saccharogenic method for the extrusion-cooked beer adjunct; Application date: Dec. 9, 2005) and CN200610070044.7 (Saccharogenic method of the extrusion-cooked beer adjunct; Application date: Nov. 7, 2006), all to Shen Dechao, have resolved the above-mentioned difficulties in the saccharification and filtration of the resulting mash from the extrusion-cooked beer adjunct. Nevertheless, both the magnitude and the stability of the increase in recoverable ratio of wort extract was not ideal.

Chinese patent CN200710015500.2 to Shen Dechao (Title: Processing method and processing device for the extrusion of beer adjunct with enzymes added, and saccharogenic method for the extruded beer adjunct; Application date: May 11, 2007), on the basis of the above patents, involves the extrusion of beer adjunct with enzymes added which results in a relatively higher recoverable ratio of wort extract.

However, the above-mentioned patents did not disclose the amount of enzymes added prior to extrusion of beer adjunct, and the amount of enzymes added in the mashing and liquifying stage of the extruded beer adjunct. The processing method for the extrusion of beer adjunct with or without enzymes added as well as the saccharogenic method for the extruded beer adjunct are still less than appropriate, and the configurations and parameters of the processing device need further improvement. Extensive experiments indicated that there is still room for the increase in the recoverable ratio of wort extract, mainly because the extent of degradation of the starch in the adjuncts, although better than that in the conventional adjuncts without extrusion and without enzyme added prior to extruded, is far from thorough. This problem is associated with the processing method and the processing device for the extrusion of beer adjunct with enzymes added and the saccharogenic method for the extruded beer adjunct, and the same is true for the extrusion of beer adjunct without enzymes added.

Only by overcoming the disadvantages of above prior art patents, can the starch in the beer adjunct extruded with or without enzymes added be degraded more thoroughly, and the recoverable ratio of wort extract which is the production yield of beer, be increased further.

### SUMMARY OF THE INVENTION

This invention provides a processing method and a device for the extrusion of beer adjunct with or without enzymes added, and a saccharogenic method for the extruded beer adjunct, wherein said processing method and device are such that the starch in the beer adjunct extruded with or without enzymes added can be degraded more thoroughly, and the recoverable ratio of wort extract and therefore the production yield of beer can be increased further, as compared to the technology of the above-described prior art.

This invention adopts the following technical solutions to overcome the above disadvantages of the prior art.

In one aspect of this invention, there is provided a device for the extrusion of beer adjunct with or without enzymes added.

The device substantially comprises a whole of an axially bisectable barrel set and a whole of screw set. The whole of barrel set comprises the first barrel 2, the second barrel 4, the third barrel 5 and the fourth barrel 7, wherein each barrel is axially bisectable and the whole of the barrel set is thus also axially bisectable. The first barrel 2, the second barrel 4, the third barrel 5 and the fourth barrel 7 are assembled in the numbering order and can be closed by locking the upper part and lower part of each of the above-said barrels with fasteners. The whole of screw set comprises the main shaft 15, the first screw 1, the second screw 6 and the third screw 10, wherein each screw is installed enclosing the main shaft 15 in the numbering order and rotates with the main shaft 15. The two bisectable halves of the whole of barrel set consisting of the corresponding two bisectable halves of the first barrel 2, the second barrel 4, the third barrel 5 and the fourth barrel 7 assembled together can be rotated outwardedly around shaft A and shaft B respectively so that the two bisectable halves of the whole of the barrel set are opened apart from each other.

The whole of screw set has a length-diameter ratio of 5-20 and a compression ratio of 5-35. The first screw 1, the second screw 6 and the third screw 10 enclosing the main shaft 15 have external threads in the opposite rotational direction to the continuous internal thread on the inner surface of the second barrel 4, the third barrel 5 and the fourth barrel 7. The external threads of the second screw 6 and the third screw 10 have a helix angle approximately equal to the helix angle of the continuous internal thread on the inner surface of the second barrel 4, the third barrel 5 and the fourth barrel 7. The volume between the end surface of the small end of the third screw 10 and the internal surface of die plate 8 should be 0.3 to 7 times the theoretical output volume produced when the small end of the third screw 10 rotates one revolution. The die nozzle 9 of the die plate 8 has an adjustable diameter ranging from φ3 mm to φ18 mm and an adjustable length ranging from 5 mm to 25 mm.

In another aspect of this invention, there is provided a processing method for the extrusion of beer adjunct with or without enzymes added, wherein the extruded beer adjunct is used for brewing beer.

The beer adjunct, with a moisture content percentage of less than 15.5% before extrusion, is milled and passed through a sieve with a mesh of 1.0 mm to 7 mm. Then the milled beer adjunct is adjusted to a moisture content percentage of 15% to 50% and is added or not added with a suitable amount of enzymes. The beer adjunct mixture thus obtained is subjected to extrusion using the above-said device. The first barrel 2 is not heated or cooled. The second barrel 4, the third barrel 5 and the fourth barrel 7 are in an automatically adjustable temperature ranging from 13° C. to 60° C., 13° C. to 110° C. and 20° C. to 155° C. respectively. The whole of the screw set consisting of the first screw 1, the second screw 6 and the third screw 10 rotates at an adjustable rotation speed ranging from 40 rpm to 280 rpm. The beer adjunct material extruded with or without enzymes added is minced by the cutter and cooled to room temperature. Then the beer adjunct material is subjected to air-drying or low-temperature drying with the temperature of drying no higher than 85° C. The dried beer adjunct, with a moisture content percentage of less than 15%, is milled and passed through a sieve with a mesh of 2 mm to 10 mm. Alternatively, the beer adjunct extruded with or without enzymes added is minced by the cutter for later use.

The enzymes added to the beer adjunct before extrusion include one kind or more kinds of high temperature-resistant α-amylase, high-efficient thermostable α-amylase, medium-temperature amylase, glucoamylase, glucose amylase, high-efficient glucoamylase and strongly-efficient glucoamylase, and the suitable amount of addition is 0.3 L to 3 L or 0.3 kg to 3 kg per ton of beer adjunct.

The beer adjunct extruded with or without enzymes added includes one kind or more kinds of rice, degermed corn, undegermed corn, sorghum, barley, wheat, or starch or raw starch thereof, extruded with or without enzymes added.

In yet another aspect of this invention, there are provided saccharogenic methods for the beer adjunct extruded with or without enzymes added, wherein the following saccharogenic method I or saccharogenic method II is used if a higher recoverable ratio of wort extract is desired, and the following saccharogenic method III is used if a shorter saccharification time is desired.

As the saccharogenic method I, the beer adjunct extruded with or without enzymes added is milled or minced and added into the water in the mash tank (or saccharifying tank), or the extruded beer adjunct is added together with water into the mash tank (or saccharogenic tank). The temperature of the water is in the range of room temperature to 53° C. and the ratio of extruded beer adjunct to water is in the range of 1:2.0 to 1:6.5. Also added are suitable amounts of calcium ion, acid reagent and one kind or more kinds of high temperature-resistant α-amylase, high-efficient thermostable α-amylase, medium-temperature amylase, glucoamylase, glucose amylase, high-efficient glucoamylase and strongly-efficient glucoamylase. The mash thus obtained, at a pH ranging from 6.0 to 7.0, is heated to 65° C. to 95° C. and held at this temperature for 20 min to 55 min. Then a suitable amount of water at a temperature of 15° C. to 25° C. is added and mixed so that the mash is at a temperature of 45° C. to 53° C. At the same time, suitable amounts of calcium ion, acid reagent and malt grist are added. The malt grist and the already-added water at a temperature of 15° C. to 25° C. are in a ratio of 1:3-4.0. If the malt grist is of inferior quality, then a suitable amount of one kind or more kinds of glucoamylase, protease and compound enzymes may be added. The mash obtained, at a pH ranging from 5.0 to 6.5, is held at the temperature of 45° C. to 53° C. for 55 min to 65 min. Then the temperature is raised to 60° C. to 70° C. and the mash is held at this temperature for 20 min to 80 min. If the mash passes the iodine test, it is raised to a temperature of 73° C. to 80° C. and filtered at this temperature. Otherwise, it is raised to a temperature of 65° C. to 78° C. and held at this temperature for 2 min to 45 min until it passes the iodine test, then it is raised to a temperature of 73° C. to 80° C. and filtered at this temperature.

As the saccharogenic method II, the beer adjunct extruded with or without enzymes added is milled or minced and added together with malt grist into the water in the mash tank (or saccharifying tank), or the extruded beer adjunct and malt grist are added together with water into the mash tank (or saccharifying tank). The temperature of the water is in the range of room temperature to 45° C. and the ratio of extruded beer adjunct and malt grist to water is in the range of 1:2.0 to 1:6.5. Also added are suitable amounts of calcium ion, acid reagent and one kind or more kinds of high temperature-resistant α-amylase, high-efficient thermostable α-amylase, medium-temperature amylase, glucoamylase, glucose amylase, high-efficient glucoamylase and strongly-efficient glucoamylase. If the malt grist is of inferior quality, then a suitable amount of one kind or more kinds of glucoamylase, protease and compound enzymes may be added. The mash thus obtained, at a pH ranging from 5.0 to 7.0, is heated to 45° C. to 53° C. and held at this temperature for 55 min to 65 min. Then it is raised to a temperature of 60° C. to 70° C. and held at this temperature for 20 min to 80 min. If the mash passes the iodine test, it is raised to a temperature of 73° C. to 80° C. and filtered at this temperature. Otherwise, it is raised to a temperature of 65° C. to 78° C. and held at this temperature for 2 min to 45 min until it passes the iodine test, then it is raised to a temperature of 73° C. to 80° C. and filtered at this temperature.

As the saccharifying method III, the beer adjunct extruded with or without enzymes added is milled or minced and added into the water in the mash tank, or the extruded beer adjunct is added together with water into the mash tank. The temperature of the water is in the range of room temperature to 65° C. and the ratio of extruded beer adjunct to water is in the range of 1:2.0 to 1:6.5. Also added are suitable amounts of calcium ion, acid reagent and one kind or more kinds of high temperature-resistant α-amylase, high-efficient thermostable α-amylase, medium-temperature amylase, glucoamylase, glucose amylase, high-efficient glucoamylase and strongly-efficient glucoamylase. The mash thus obtained, at a pH range from 6.0 to 7.0, is heated to 65° C. to 95° C. and held for 20 min to 55 min. At a suitable time before this, the saccharifying tank is added with a suitable amount of water at a temperature of 36° C. to 53° C. followed by malt grist, or the malt grist and the water are added together into the saccharifying tank. At the same time, suitable amounts of calcium ion and acid reagent are added. The ratio of malt grist to water is in the range of 1:3.0-4.0. If the malt grist is of inferior quality, then a suitable amount of one kind or more kinds of glucoamylase, protease and compound enzymes may be added. The mash thus obtained is at a pH ranging from 5.0 to 6.5. If the malt grist is added with the water temperature being 36° C. to 45° C., the mash is held at this temperature for 10 min to 25 min. Then it is raised to a temperature of 45° C. to 53° C. and held at this temperature for 55 min to 65 min. Or if the malt grist is added with the water temperature being 45° C. to 53° C., the mash is held at this temperature for 55 min to 65 min. Subsequently, the mash in the saccharifying tank and the mash in the mash tank which is heated to 65° C. to 95° C. and held at this temperature for 20 min to 55 min are mixed together and the mixed mash is raised to a temperature of 60° C. to 70° C. and held at this temperature for 20 min to 80 min. If the mash passes the iodine test, it is raised to a temperature of 73° C. to 80° C. and filtered at this temperature. Otherwise, it is raised to a temperature of 65° C. to 78° C. and held at this temperature for 2 min to 45 min until it passes the iodine test, then it is raised to a temperature of 73° C. to 80° C. and filtered at this temperature.

As the above saccharogenic methods I, II and III, one kind or more kinds of high temperature-resistant α-amylase, high-efficient thermostable α-amylase, medium-temperature amylase, glucoamylase, glucose amylase, high-efficient glucoamylase and strongly-efficient glucoamylase are added into the mash tank (or saccharifying tank ) in a suitable amount of 0.2 L to 1.5 L or 0.2 kg to 1.5 kg per ton of beer adjunct.

As the above saccharogenic method I, II and III, if the malt grist is of inferior quality, one kind or more kinds of glucoamylase, protease and compound enzymes may be added into the saccharifying tank (or mash tank) in a suitable amount of 0.3 L to 2.0 L or 0.3 kg to 2.0 kg per ton of malt grist.

During raising the temperature of the mash in the mash tank (or saccharifying tank), the paddles stir the mash rotate at a speed of 4 rpm to 100 rpm, while during keeping the mash at certain temperature, the paddles rotate at a speed of 1 rpm to 70 rpm.

This invention has the following advantages as compared to the prior art:

1. This invention discloses the parameters for the processing method and the device for the extrusion of beer adjunct with or without enzymes added, which were not disclosed in the prior art. Therefore starch that is the main component of the beer adjunct can be degraded more thoroughly during extrusion and subsequent saccharification.

2. This invention discloses the addition amount of thermostable α-amylase, high-efficient high temperature-resistant α-amylase, medium-temperature amylase, glucoamylase, glucose amylase, high-efficient glucoamylase and strongly-efficient glucoamylase during the extrusion process, and the addition amount of thermostable α-amylase, high-efficient high temperature-resistant α-amylase and medium-temperature amylase during the subsequent mashing and saccharifying of above extruded beer adjunct, which addition amounts were not disclosed in the prior art.

3. This invention discloses saccharogenic method for the beer adjunct extruded with or without enzymes added, that as compared to the prior-art processes for the saccharification of the beer adjunct extruded with or without enzymes added and processes for the saccharification of the traditional unextruded beer adjunct, have a shorter saccharification time, a faster filtration speed, an apt degradation of starch into dextrins, oligosaccharides, reducing sugars and glucose or the like, and thus a higher recoverable ratio of wort extract.

### BRIEF DESCRIPTION OF DRAWINGS

FIG. 1 is the front view of the device of this invention for the extrusion of beer adjunct with or without enzymes added.

FIG. 2 is the half-sectional view of the top view of the device of this invention for the extrusion of beer adjunct with or without enzymes added.

### DETAILED DESCRIPTION

This invention is further described with reference to the drawings.

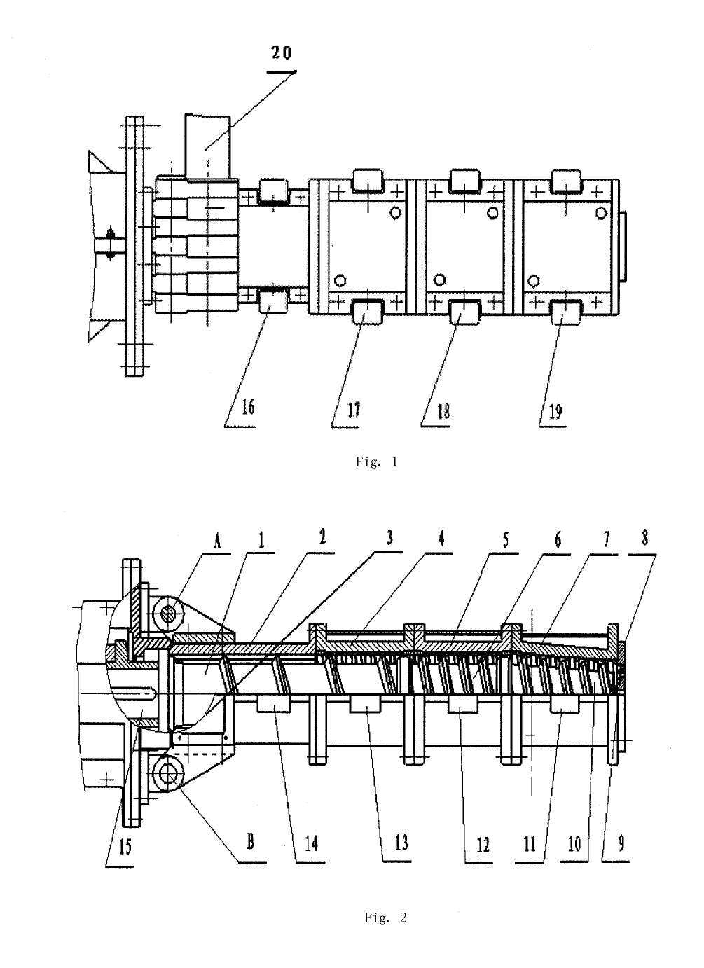

The beer adjunct, with a moisture content percentage of less than 15.5% before extrusion, is milled and passed through a sieve with a mesh of 4 mm. Then the milled beer adjunct is adjusted to a moisture content percentage of 27% to 32% and is added or not added with a suitable amount of enzymes. In the case of enzyme addition, the enzyme added is thermostable α-amylase in an amount of 0.85 L or 0.85 kg per ton of beer adjunct. The above milled beer adjunct with or without a suitable amount of enzymes added is then fed through feed inlet 20 into the extrusion device (See FIG. 1 and FIG. 2). The beer adjunct is rotated and pushed forward by the main shaft 15, the first screw 1, the second screw 6 and the third screw 10 in the extrusion cavity formed between the outer surfaces of the first screw 1, the second screw 6 and the third screw 10 and the inner surfaces of the first barrel 2, the second barrel 4, the third barrel 5 and the fourth barrel 7. Meanwhile, the beer adjunct in the extrusion cavity is heated or cooled by the barrels through thermal conduction. The extruded beer adjunct moving along with the first screw 1, the second screw 6 and the third screw 10 is finally extruded out of the die nozzle 9 of the die plate 8.

This invention provides a device for the extrusion of beer adjunct with or without enzymes added, as shown in FIG. 1 and FIG. 2.

The device basically comprises a whole of an axially bisectable barrel set and a whole of a screw set. The whole of barrel set comprises the first barrel 2, the second barrel 4, the third barrel 5 and the fourth barrel 7, wherein each barrel is axially bisectable and the whole of the barrel set is thus also axially bisectable after assembled. The first barrel 2, the second barrel 4, the third barrel 5 and the fourth barrel 7 are assembled in the numbering order and can be closed by locking the upper part and lower part of each of the above-said barrels with fasteners. The whole of the screw set comprises the main shaft 15, the first screw 1, the second screw 6 and the third screw 10, wherein each screw is installed enclosing the main shaft 15 in the numbering order and rotates with the main shaft 15. The two bisectable halves of the whole of the barrel set consisting of the corresponding two bisectable halves of the first barrel 2, the second barrel 4, the third barrel 5 and the fourth barrel 7 assembled together can be rotated outwardedly around shaft A and shaft B respectively so that the two bisectable halves of the whole of the barrel set are opened apart from each other.

The whole of the screw set has a length-diameter ratio of 9 and a compression ratio of 10. The first screw 1, the second screw 6 and the third screw 10 enclosing the main shaft 15 have external threads in the opposite rotational direction to the continuous internal thread on the inner surface of the second barrel 4, the third barrel 5 and the fourth barrel 7. The external threads of the second screw 6 and the third screw 10 have a helix angle approximately equal to the helix angle of the continuous internal thread on the inner surface of the second barrel 4, the third barrel 5 and the fourth barrel 7. The volume between the end surface of the small end of the third screw 10 and the internal surface of die plate 8 should be 5 times the theoretical output volume produced when the small end of the third screw 10 rotates one revolution. The diameter of die nozzle 9 of the die plate 8 is φ14 mm. The length of nozzle is 15 mm.

This invention also provides a processing method for the extrusion of beer adjunct with or without enzymes added, wherein the extruded beer adjunct is used for brewing beer.

The first barrel 2 is not heated or cooled. The second barrel 4, the third barrel 5 and the fourth barrel 7 are heated at a temperature of 50° C., 90° C. and 120° C. respectively. The whole of the screw set consisting of the first screw 1, the second screw 6 and the third screw 10 rotates at a rotation speed of 220 rpm. The beer adjunct extruded with or without enzymes added is minced by the cutter and cooled to room temperature. Then the beer adjunct is subjected to air-drying or low-temperature drying with the temperature of drying no higher than 75° C. The dried beer adjunct, with a moisture content percentage of less than 15%, is milled and passed through a screen with a mesh of 5 mm. Alternatively, the beer adjunct material extruded with or without enzymes added is minced by the cutter for later use.

The beer adjunct extruded with or without enzymes added includes one kind or more kinds of rice, degermed corn, undegermed corn, sorghum, barley, wheat, or starch or raw starch thereof, extruded with or without enzymes added.

This invention further provides saccharogenic method for the beer adjunct extruded with or without enzymes added, wherein the following saccharogenic method I or II is used if a higher recoverable ratio of wort extract is desired, and the following saccharogenic method III is used if a shorter saccharification time is desired.

As the saccharogenic method I, the beer adjunct extruded with or without enzymes added is milled or minced and added into the water in the mash tank (or saccharifying tank), or the extruded beer adjunct is added together with water into the mash tank (or saccharifying tank). The temperature of the water is in the range of room temperature to 53° C. and the ratio of extruded beer adjunct to water is in the range of 1:4.5. Also added are suitable amounts of calcium ion, acid reagent and thermostable α-amylase. The mash thus obtained, at a pH ranging from 6.0 to 7.0, is heated to 90° C. and held at this temperature for 40 min. Then a suitable amount of water at a temperature of 15° C. to 25° C. is added and mixed so that the mash is at a temperature of 52° C. At the same time, suitable amounts of calcium ion, acid reagent and malt grist are added. The malt grist and the already-added water at a temperature of 15° C. to 25° C. are in a ratio of 1:3.8. If the malt grist is of inferior quality, then a suitable amount of compound enzymes may be added. The mash obtained, at a pH ranging from 5.0 to 6.5, is held at the temperature of 50° C. for 60 min. Then the temperature is raised to 68° C. and the mash is held for 60 min. The mash obtained that passes the iodine test is raised to a temperature of 78° C. and filtered at this temperature.

As the saccharogenic method II, the beer adjunct extruded with or without enzymes added is milled or minced and added together with malt grist into the water in the mash tank (or saccharifying tank), or the extruded beer adjunct and malt grist are added together with water into the mash tank (or saccharifying tank). The temperature of the water is in the range of room temperature to 45° C. and the ratio of extruded beer adjunct and malt grist to water is in the range of 1:2.0 to 1:6.5. Also added are suitable amounts of calcium ion, acid reagent and thermostable α-amylase. If the malt grist is of inferior quality, then a suitable amount of glucoamylase and compound enzymes may be added. The mash thus obtained, at a pH ranging from 5.0 to 7.0, is heated to 48° C. and held for 60 min. Then it is raised to a temperature of 63° C. and held for 60 min. Again it is raised to a temperature of 70° C. and held for 20 min until it passes the iodine test, then it is raised to a temperature of 78° C. and filtered at this temperature.

As the saccharogenic method III, the beer adjunct extruded with or without enzymes added is milled or minced and added into the water in the mash tank, or the extruded beer adjunct is added together with water into the mash tank. The temperature of the water is in the range of room temperature to 53° C. and the ratio of extruded beer adjunct to water is in the range of 1:4.5. Also added are suitable amounts of calcium ion, acid reagent and thermostable α-amylase. The mash thus obtained, at a pH ranging from 6.0 to 7.0, is heated to 90° C. and held at this temperature for 40 min. At a suitable time before this, the saccharifying tank is added with a suitable amount of water at a temperature of 50° C. followed by malt grist, or the malt grist and the water are added together into the saccharifying tank. At the same time, suitable amounts of calcium ion and acid reagent are added. The ratio of malt grist to water is in the range of 1:3.8. If the malt grist is of inferior quality, then a suitable amount of compound enzymes may be added. The mash thus obtained, at a pH range ranging from 5.0 to 6.5, is held at 50° C. for 60 min. Subsequently, the mash in the saccharifying tank and the mash in the mash tank which is heated to 90° C. and held for 40 min are mixed together and the mixed mash is raised to a temperature of 68° C. and held at this temperature for 60 min. The mash obtained that passes the iodine test is raised to a temperature of 78° C. and filtered at this temperature.

As the above saccharogenic method I, II and III, thermostable α-amylase are added into the mash tank (or saccharifying tank) in a suitable amount of 0.5 L or 0.5 kg per ton of beer adjunct.

As the above saccharogenic method I, II and III, if the malt grist is of inferior quality, glucoamylase may be added into the mash tank (or saccharifying tank) in a suitable amount of 1 L or 1.0 kg per ton of malt grist.

During raising the temperature of the mash in the mash tank or in the saccharifying tank, the paddles stir the mash rotate at a speed of 50 rpm, while during keeping the mash at certain temperature, the paddles rotate at a speed of 40 rpm.

1. A device for the extrusion of beer adjunct with or without enzymes added, characterized in that said device substantially comprises a whole of an axially bisectable barrel set and a whole of a screw set; the whole of the barrel set comprises a first barrel (2), a second barrel (4), a third barrel (5) and a fourth barrel (7), wherein each barrel is axially bisectable and the whole of the barrel set is thus also axially bisectable; the first barrel (2), the second barrel (4), the third barrel (5) and the fourth barrel (7) are assembled in the numbering order and can be closed by locking an upper part and a lower part of each of the above-said barrels with fasteners; the whole of the screw set comprises a main shaft (15), a first screw (1), a second screw (6) and a third screw (10), wherein each screw is installed enclosing the main shaft (15) in the numbering order and rotates with the main shaft (15); the two bisectable halves of the whole of the barrel set consisting of the corresponding two bisectable halves of the first barrel (2), the second barrel (4), the third barrel (5) and the fourth barrel (7) assembled together can be rotated outwardedly around shaft A and shaft B respectively, so that the two bisectable halves of the barrel set are opened apart from each other; the whole of the screw set has a length-diameter ratio of 5-20 and a compression ratio of 5-35; the first screw (1), the second screw (6) and the third screw (10) enclosing the main shaft (15) have external threads in the opposite rotational direction to a continuous internal thread on the inner surface of the second barrel (4), the third barrel (5) and the fourth barrel (7); the external threads of the second screw (6) and the third screw (10) have a helix angle equal approximately to the helix angle of the continuous internal thread on the inner surface of the second barrel (4), the third barrel (5) and the fourth barrel (7); a volume between an end surface of a small end of the third screw (10) and an internal surface of die plate (8) being 0.3 to 7 times the theoretical output volume produced when the small end of the third screw (10) rotates one revolution; a die nozzle (9) of the die plate (8) has an adjustable diameter ranging from φ3 mm to φ18 mm and an adjustable length ranging from 5 mm to 25 mm.

2. A processing method for the extrusion of beer adjunct with or without enzymes added, wherein the extruded beer adjunct is used for brewing beer, characterized in that the beer adjunct, with a moisture content percentage of less than 15.5% before extrusion, is milled and passed through a sieve with a mesh of 1.0 mm to 7 mm; then the milled beer adjunct is adjusted to a moisture content percentage of 15% to 50% and is added or not added with a suitable amount of enzymes; the beer adjunct mixture thus obtained is subjected to extrusion using the device according to claim 1, wherein the first barrel (2) is not heated or cooled; the second barrel (4), the third barrel (5) and the fourth barrel (7) are in an automatically adjustable temperature ranging from 13° C. to 60° C., 13° C. to 110° C. and 20° C. to 155° C. respectively; the whole of the screw set consisting of the first screw (1), the second screw (6) and the third screw (10) rotates at an adjustable rotation speed ranging from 40 rpm to 280 rpm; the beer adjunct extruded with or without enzymes added is minced by the cutter and cooled to room temperature; then the beer adjunct is subjected to air-drying or low-temperature drying with the temperature of drying no higher than 85° C.; the dried beer adjunct, with a moisture content percentage of less than 15%, is then either milled and passed through a sieve with a mesh of 2 mm to 10 mm, or alternatively, the beer adjunct extruded with or without enzymes added is minced by the cutter for later use.

3. The processing method according to claim 2, characterized in that the enzymes added to the beer adjunct before extrusion include one kind or more kinds of high temperature-resistant α-amylase, high-efficient thermostable α-amylase, medium-temperature amylase, glucoamylase, glucose amylase, high-efficient glucoamylase and strongly-efficient glucoamylase.

4. The processing method according to claim 3, characterized in that the high temperature-resistant α-amylase, high-efficient thermostable α-amylase, medium-temperature amylase, glucoamylase, glucose amylase, high-efficient glucoamylase and strongly-efficient glucoamylase are added in an amount of 0.3 L to 3 L or 0.3 kg to 3 kg per ton of beer adjunct.

5. The processing method according to claim 2, characterized in that the beer adjunct extruded with or without enzymes added includes one kind or more kinds of rice, degermed corn, undegermed corn, sorghum, barley, wheat, or starch or raw starch thereof, extruded with or without enzymes added.

6. The saccharogenic method for the extruded beer adjunct according to claim 5, characterized in that saccharogenic method I or II is used if a higher recoverable ratio of wort extract is desired, and saccharogenic method III is used if a shorter saccharification time is desired.

7. The saccharogenic method I according to claim 6, characterized in that the beer adjunct extruded with or without enzymes added is milled or minced and added into the water in the mash tank (or saccharifying tank), or the extruded beer adjunct is added together with water into the mash tank (or saccharifying tank); the temperature of the water is in the range of room temperature to 53° C. and the ratio of extruded beer adjunct to water is in the range of 1:2.0 to 1:6.5; also added are suitable amounts of calcium ion, acid reagent and one kind or more kinds of high temperature-resistant α-amylase, high-efficient thermostable α-amylase, medium-temperature amylase, glucoamylase, glucose amylase, high-efficient glucoamylase and strongly-efficient glucoamylase; the mash thus obtained, at a pH ranging from 6.0 to 7.0, is heated to 65° C. to 95° C. and held at this temperature for 20 min to 55 min; then a suitable amount of water at a temperature of 15° C. to 25° C. is added and mixed so that the mash is at a temperature of 45° C. to 53° C.; at the same time, suitable amounts of calcium ion, acid reagent and malt grist are added; the malt grist and the already-added water at a temperature of 15° C. to 25° C. are in a ratio of 1:3.0-4.0; if the malt grist is of inferior quality, then a suitable amount of one kind or more kinds of glucoamylase, protease and compound enzymes may be added; the mash obtained, at a pH ranging from 5.0 to 6.5, is held at the temperature of 45° C. to 53° C. for 55 min to 65 min; then the temperature is raised to 60° C. to 70° C. and the mash is held at this temperature for 20 min to 80 min; if the mash passes the iodine test, it is raised to a temperature of 73° C. to 80° C. and filtered at this temperature; otherwise, it is raised to a temperature of 65° C. to 78° C. and held at this temperature for 2 min to 45 min until it passes the iodine test, then it is raised to a temperature of 73° C. to 80° C. and filtered at this temperature.

8. The saccharogenic method II according to claim 6, characterized in that the beer adjunct extruded with or without enzymes added is milled or minced and added together with malt grist into the water in the mash tank (or saccharifying tank), or the extruded beer adjunct and malt grist are added together with water into the mash tank (or saccharifying tank); the temperature of the water is in the range of room temperature to 45° C. and the ratio of extruded beer adjunct and malt grist to water is in the range of 1:2.0 to 1:6.5; also added are suitable amounts of calcium ion, acid reagent and one kind or more kinds of high temperature-resistant α-amylase, high-efficient thermostable α-amylase, medium-temperature amylase, glucoamylase, glucose amylase, high-efficient glucoamylase and strongly-efficient glucoamylase; if the malt grist is of inferior quality, then a suitable amount of one kind or more kinds of glucoamylase, protease and compound enzymes may be added; the mash thus obtained, at a pH ranging from 5.0 to 7.0, is heated to 45° C. to 53° C. and held for 55 min to 65 min; then it is raised to a temperature of 60° C. to 70° C. and held for 20 min to 80 min; if the mash passes the iodine test, it is raised to a temperature of 73° C. to 80° C. and filtered at this temperature; otherwise, it is raised to a temperature of 65° C. to 78° C. and held at this temperature for 2 min to 45 min until it passes the iodine test, then it is raised to a temperature of 73° C. to 80° C. and filtered at this temperature.

9. The saccharogenic method III according to claim 6, characterized in that the beer adjunct extruded with or without enzymes added is milled or minced and added into the water in the mash tank, or the extruded beer adjunct is added together with water into the mash tank; the temperature of the water is in the range of room temperature to 65° C. and the ratio of extruded beer adjunct to water is in the range of 1:2.0 to 1:6.5; also added are suitable amounts of calcium ion, acid reagent and one kind or more kinds of high temperature-resistant α-amylase, high-efficient thermostable α-amylase, medium-temperature amylase, glucoamylase, glucose amylase, high-efficient glucoamylase and strongly-efficient glucoamylase; the mash thus obtained, at a pH ranging from 6.0 to 7.0, is heated to 65° C. to 95° C. and held for 20 min to 55 min at this temperature; at a suitable time before this, the saccharifying tank is added with a suitable amount of water at a temperature of 36° C. to 53° C. followed by malt grist, or the malt grist and the water are added together into the saccharifying tank; at the same time, suitable amounts of calcium ion and acid reagent are added; the ratio of malt grist to water is in the range of 1:3.0-4.0; if the malt grist is of inferior quality, then a suitable amount of one kind or more kinds of glucoamylase, protease and compound enzymes may be added; the mash thus obtained is at a pH ranging from 5.0 to 6.5; if the malt grist is added with the water temperature being 36° C. to 45° C., the mash is held at this temperature for 10 min to 25 min; then it is raised to a temperature of 45° C. to 53° C. and held at this temperature for 55 min to 65 min; or if the malt grist is added with the water temperature being 45° C. to 53° C., the mash is held at this temperature for 55 min to 65 min; subsequently, the mash in the saccharifying tank and the mash in the mash tanke which is heated to 65° C. to 95° C. and held for 20 min to 55 min are mixed together and the mixed mash is raised to a temperature of 60° C. to 70° C. and held at this temperature for 20 min to 80 min; if the mash passes the iodine test, it is raised to a temperature of 73° C. to 80° C. and filtered at this temperature; otherwise, it is raised to a temperature of 65° C. to 78° C. and held for 2 min to 45 min until it passes the iodine test, then it is raised to a temperature of 73° C. to 80° C. and filtered at this temperature.

10. The saccharogenic method I, II and III according to claim 7, characterized in that the one kind or more kinds of high temperature-resistant α-amylase, high-efficient thermostable α-amylase, medium-temperature amylase, glucoamylase, glucose amylase, high-efficient glucoamylase and strongly-efficient glucoamylase that are added into the mash tank (or saccharifying tank) are in a suitable amount of 0.2 L to 1.5 L or 0.2 kg to 1.5 kg per ton of beer adjunct.

11. The saccharogenic method I, II and III according to claim 8, characterized in that the one kind or more kinds of high temperature-resistant α-amylase, high-efficient thermostable α-amylase, medium-temperature amylase, glucoamylase, glucose amylase, high-efficient glucoamylase and strongly-efficient glucoamylase that are added into the mash tank (or saccharifying tank) are in a suitable amount of 0.2 L to 1.5 L or 0.2 kg to 1.5 kg per ton of beer adjunct.

12. The saccharogenic method I, II and III according to claim 9, characterized in that the one kind or more kinds of high temperature-resistant α-amylase, high-efficient thermostable α-amylase, medium-temperature amylase, glucoamylase, glucose amylase, high-efficient glucoamylase and strongly-efficient glucoamylase that are added into the mash tank (or saccharifying tank) are in a suitable amount of 0.2 L to 1.5 L or 0.2 kg to 1.5 kg per ton of beer adjunct.

13. The saccharogenic method I, II and III according to claim 7, characterized in that the one kind or more kinds of glucoamylase, protease and compound enzymes that may be added into the saccharifying tank (or mash tank) if the malt grist is of inferior quality are in a suitable amount of 0.3 L to 2.0 L or 0.3 kg to 2.0 kg per ton of malt grist.

14. The saccharogenic method I, II and III according to claim 8, characterized in that the one kind or more kinds of glucoamylase, protease and compound enzymes that may be added into the saccharifying tank (or mash tank) if the malt grist is of inferior quality are in a suitable amount of 0.3 L to 2.0 L or 0.3 kg to 2.0 kg per ton of malt grist.

15. The saccharogenic method I, II and III according to claim 9, characterized in that the one kind or more kinds of glucoamylase, protease and compound enzymes that may be added into the saccharifying tank (or mash tank) if the malt grist is of inferior quality are in a suitable amount of 0.3 L to 2.0 L or 0.3 kg to 2.0 kg per ton of malt grist.

16. The saccharogenic method I, II and III according to claim 7, characterized in that during raising the temperature of the mash in the mash tank or in the saccharifying tank, the paddles which stir the mash, rotate at a speed of 4 rpm to 100 rpm, while during keeping the mash at certain temperature, the paddles rotate at a speed of 1 rpm to 70 rpm.

17. The saccharogenic method I, II and III according to claim 8, characterized in that during raising the temperature of the mash in the mash tank or in the saccharifying tank, the paddles which stir the mash, rotate at a speed of 4 rpm to 100 rpm, while during keeping the mash at certain temperature, the paddles rotate at a speed of 1 rpm to 70 rpm.

18. The saccharogenic method I, II and III according to claim 9, characterized in that during raising the temperature of the mash in the mash tank or in the saccharifying tank, the paddles which stir the mash, rotate at a speed of 4 rpm to 100 rpm, while during keeping the mash at certain temperature, the paddles rotate at a speed of 1 rpm to 70 rpm.
